(19) United States
(12) Patent Application Publication
(10) Pub. No.: US 2026/0154469 A1
(43) Pub. Date: Jun. 4, 2026

(54) METHOD OF GENERATING PIPE CONSTRUCTION DRAWING INCLUDING WELD MAP FROM 3D MODEL OF PLANT

(71) Applicant: SAMSUNG E&A CO., LTD., Seoul (KR)

(72) Inventors: Sung Keun KIM, Seoul (KR); Jae Young OH, Seoul (KR); Seung June LEE, Seoul (KR); Su Min LEE, Seoul (KR); Sang Hun RIM, Seoul (KR)

(73) Assignee: SAMSUNG E&A CO., LTD., Seoul (KR)

(21) Appl. No.: 19/123,052

(22) PCT Filed: Jul. 5, 2023
(86) PCT No.: PCT/KR2023/009452

§ 371 Date: Apr. 21, 2025

(30) Foreign Application Priority Data
Oct. 20, 2022 (KR) 10-2022-0135418

(51) Int. Cl. B29C 65/00; B29C 65/16

(52) U.S. Cl. CPC G06F 30/18; G06F 30/13; G06F 2113/14; G06F 2119/18

(57) ABSTRACT

The present invention relates to a method of generating a pipe construction drawing including a weld map from a 3D model of a plant and, more specifically, to a method of generating a pipe construction drawing including a weld map from a 3D model of a plant, the method enabling a shop welding point and a field welding point to be automatically generated during generation of a construction drawing by applying a predetermined RULE to a plant 3D model created in a plant engineering step, thereby enhancing productivity and constructability of a pipe.

### TECHNICAL FIELD

The present invention relates to a generating method of construction drawings of piping to include a weld map from 3D modeling of a plant, and more particularly, to improve the productivity and constructability of piping by automatically selecting shop welding points and field welding points when creating construction drawings by applying certain rules to the 3D modeling of the plant created in the plant engineering stage.

### BACKGROUND ART

A plant is a collection of large-scale facilities built on land or sea, and typically, is completed through an engineering step divided into a basic design, a Front-End Engineering Design (FEED), and a detailed design, and purchasing, constructing, and test-driving steps, and then commercially driven. In an engineering, procurement, and construction (EPC) step of a general plant, a process in which various data and references are generated, modified, and fixed is performed, and in a process of handing-over a factory to an client at the time of completion, a hand-over operation of transferring AS-BUILT (completion) data is also included and finally, a site acceptance test (SAT) process is performed to finish a project.

In the engineering step of the plant, in order to satisfy design conditions and design requirements given in all fields (piping, machinery, electrics, control, construction, steel frame, and civil engineering) for construction of large-scale plants, in an initial planning step, drawings are prepared with 2D CAD. Two-dimensional planning drawings are prepared depending on process conditions reflecting the requirements and process requirements of an orderer in the future, and when the preparation of the planning drawing is finished, a 3D modeling (modeling) operation is performed on the basis of the planning drawing. 3D modeling programs for plant design include HEXAGON's PDS (Plant Design System) or SmartPlant 3D (SP3D), AVEVA's E3D (Everything3D) and PDMS (Plant Design Management System), AUTODESK's Revit, Bentley's AutoPlant and PlantSpace are widely used. In the past, two-dimensional AUTOCAD was mainly used for plant design, but now, with the development of technology and the increase in computer capacity, most of the plants are designed using 3D programs. When the 3D modeling work is completed, through modeling, a two-dimensional plan drawing or isometric drawing which is a construction drawing, and an erection drawing including a weld map based on it, and a spool drawing is drawn up. Specifically, when the 3D modeling is completed, an isometric drawing for construction is created and approved by the customer, and based on the isometric drawing approved by the customer, spool drawings for pipe spool production in the shop and erection drawings for on-site construction are created. The erection drawing for on-site construction is a drawing in which shop and field joints are marked in an isometric drawing, and the spool drawing for fabrication is a drawing that the isometric drawing is divided by piping of a certain length or a certain shape and the shop welding points are marked it in order to pre-fabricate piping in a shop. Since piping erected in the plant are connected to each other by welding, certain parts of the piping are welded in advance at the shop to make the pipe spool. The manufactured spool is transported to the site and installed to be connected with other spools by welding to the site. Because of this process, the shop welding point for fabrication in the shop according to the spool drawing and the field welding point for on-site erection need to be marked and managed separately from each other. Conventionally, after performing 3D modeling, an isometric drawing is created for one line number, and a spool drawing is generated by executing a program that creates a spool drawing from the isometric drawing. When the spool drawing is output, the engineer manually marked the shop welding points and field welding points on the output two-dimensional spool drawing to create a weld map. Specifically, the weld map is a piping construction drawing, which is marked by distinguish between welding information such as shop welding points and field welding points and installation information such as bolting for piping items.

In this conventional weld map creation method, when a change occurs in the 3D modeling during the weld map creation process, a problem of drawing inconsistency that does not match with the weld map drawing may occur.

In addition, when the 3D modeling is changed, there is a problem in that it is difficult to obtain accurate data on the welding location and the amount of welding due to inconsistency between the drawing and the weld map.

### DISCLOSURE

### Technical Problem

An object of the present invention is to provide a generating method of construction drawings of piping to include a weld map from 3D modeling of a plant capable of improving the productivity and constructability of piping by enabling shop welding points and field welding points to be automatically marked when piping construction drawings are created in 3D modeling by utilizing 3D modeling data produced in the engineering stage of the plant.

### Technical Solution

In order to achieve the objects, the present invention provides a generating method of construction drawings of piping to include a weld map from 3D modeling of a plant using 3D modeling program implemented by a computer comprising the steps of: (a) modeling the piping of the plant by dividing into a fabrication item or a field erection item using the plant 3D modeling program; (b) setting up a certain RULE for selecting a shop welding point and a field welding point in the modeled 3D piping divided into the fabrication item or the field erection item; (c) marking a welding number to the 3D modeled piping by dividing into a shop welding point or a field welding point according to the certain RULE for each line number; (d) marking a spool number on the piping to divide the piping with the welding number for each line number into fabrication drawings; (e) generating an erection drawing by dividing the piping with the welding number and the spool number by line number; and (f) generating a fabrication drawing for each spool number in order to manufacture a spool from the erection drawing.

In step (a), the piping is basically set up as a fabrication item, and the field erection item of the piping is modeled separately.

In step (b), a certain RULE is for a piping item to which the field welding point is applied so that the field welding point can be automatically assigned to the piping.

The certain RULE for the piping item to which the field welding point is applied is to be set up so that the field welding point is applied to the branch pipe side of the TEE and LATERAL TEE and the branch pipe side of the OLET fitting.

The certain RULE for the piping item to which the field welding point is applied is to be set up so that the field welding point is applied to both sides of the pipe which the length of pipe erected in the field is determined by size and material class of pipe.

The certain RULE for the piping item to which the field welding point is applied is to be set up so that the field welding point is applied to each connection end of the width, length or height of the spool which is determined by size of SHIPPING BOX which the cargo is loaded.

The certain RULE for the piping item to which the field welding point is applied is to be set up so that the field welding point is applied to the field erection items installed by welding among the field erection items.

The certain RULE for the piping item to which the field welding point is applied is to be set up so that the field welding point is applied to the piping connected to machines operated in parallel in consideration of the field erection.

The certain RULE for the piping item to which the field welding point is applied is to be set up so that the field welding point is applied to piping connected to two or more nozzles in consideration of the field erection.

### Advantageous Effects

The present invention has the advantage that a construction drawing including a weld map can be generated by applying a certain RULE to 3D modeling created in the plant engineering stage.

In addition, the present invention has the advantage that the work efficiency for creating a weld map is improved and the schedule for creating a construction drawing including the weld map is shortened because the shop welding point and the field welding point are automatically marked on the construction drawing.

In addition, the present invention has the advantage of improving productivity for construction because it is possible to check the shop welding point and the field welding point marked on the 3D modeling.

In addition, the present invention has the advantage of reducing labor and thereby reducing cost in that since the weld map including the shop welding points and the field welding points is directly created on the 3D modeling and there is no need to directly create a separate weld map on the isometric drawing.

In addition, the present invention has the advantage of easy spool production management and field welding management.

### DESCRIPTION OF DRAWINGS

FIG. 1 is a flow chart of a generating method of construction drawings of piping to include a weld map from 3D modeling of a plant according to the present invention.

FIG. 2 is a 3D modeling diagram showing that a fabrication item and a field erection item are marked separately in 3D modeling of a plant according to the present invention.

FIG. 3 is a configuration diagram of a user interface (UI) for setting up a RULE of a generating method of construction drawings of piping to include a weld map from 3D modeling of a plant according to the present invention.

FIG. 4 is a 3D modeling diagram showing that RULE for setting up field welding points is applied to 3D modeling of a plant according to the present invention.

FIG. 5 is a 3D modeling diagram showing that a RULE according to the size of a SHIPPING BOX is applied to set up a field welding point of 3D modeling of a plant.

FIG. 6 is a 3D modeling diagram showing that RULE according to a branch pipe is applied to set up a field welding point of 3D modeling of a plant according to the present invention.

FIG. 7 is a 3D modeling diagram showing that RULE according to AIR FIN COOLER is applied to set up a field welding point of 3D modeling of a plant according to the present invention.

FIG. 8 is a 3D modeling diagram showing that RULE is applied to a parallel operation device to set up a field welding point of 3D modeling of a plant according to the present invention.

FIG. 9 is a user interface diagram showing that a welding number is marked in a 3D modeling of a plant according to the present invention.

FIG. 10 is a user interface diagram showing that a spool number is marked in a 3D modeling of a plant according to the present invention.

FIG. 11 is an erection drawing generated by a generating method of construction drawings of piping to include a weld map from 3D modeling of a plant according to the present invention.

FIG. 12 to FIG. 14 is partially enlarged views of the erection drawing of FIG. 11.

FIG. 15 is a fabrication drawing generated by a generating method of construction drawings of piping to include a weld map from 3D modeling of a plant according to the present invention.

### MODE FOR DISCLOSURE

Hereinafter, exemplary embodiments of the present invention in which the above objects can be specifically realized will be described in detail with reference to the accompanying drawings. In describing the embodiment, the same name and the same reference numeral are used with respect to the same component and the resulting additional description will be omitted.

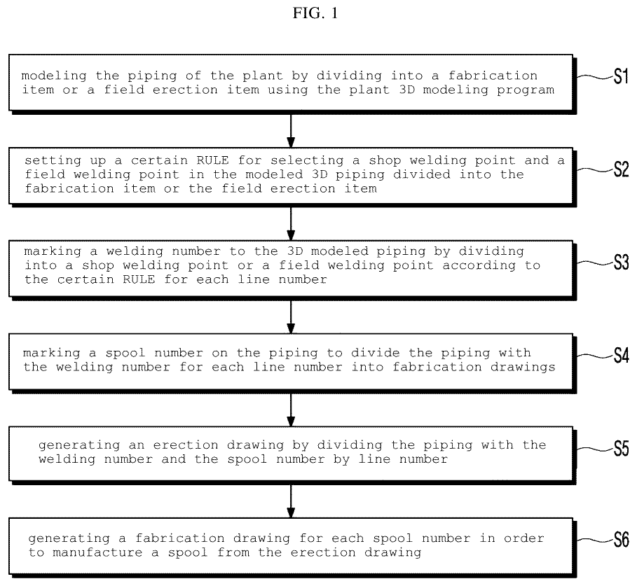

FIG. 1 is a flow chart of a generating method of construction drawings of piping to include a weld map from 3D modeling of a plant according to the present invention. As illustrated in FIG. 1, the generating method of construction drawings of piping to include a weld map from 3D modeling of a plant using 3D modeling program implemented by a computer includes: (a) modeling the piping of the plant by dividing into a fabrication item or a field erection item using the plant 3D modeling program (S1), (b) setting up a certain RULE for selecting a shop welding point and a field welding point in the modeled 3D piping divided into the fabrication item or the field erection item(S2), (c) marking a welding number to the 3D modeled piping by dividing into a shop welding point or a field welding point according to the certain RULE for each line number(S3), (d) marking a spool number on the piping to divide the piping with the welding number for each line number into fabrication drawings(S4), (e) generating an erection drawing by dividing the piping with the welding number and the spool number by line number(S5), and (f) generating a fabrication drawing for each spool number in order to manufacture a spool from the erection drawing(S6).

The generating method of construction drawings of piping to include a weld map from 3D modeling of a plant according to the present invention uses 3D modeling program implemented by a computer. Plant piping is 3D modeled through a 3D modeling program. 3D modeling programs for plant include HEXAGON's PDS (Plant Design System) or SmartPlant 3D (SP3D), AVEVA's E3D (Everything 3D) and PDMS (Plant Design Management System), AUTODESK's Revit, Bently's AutoPlant and PlantSpace are widely used.

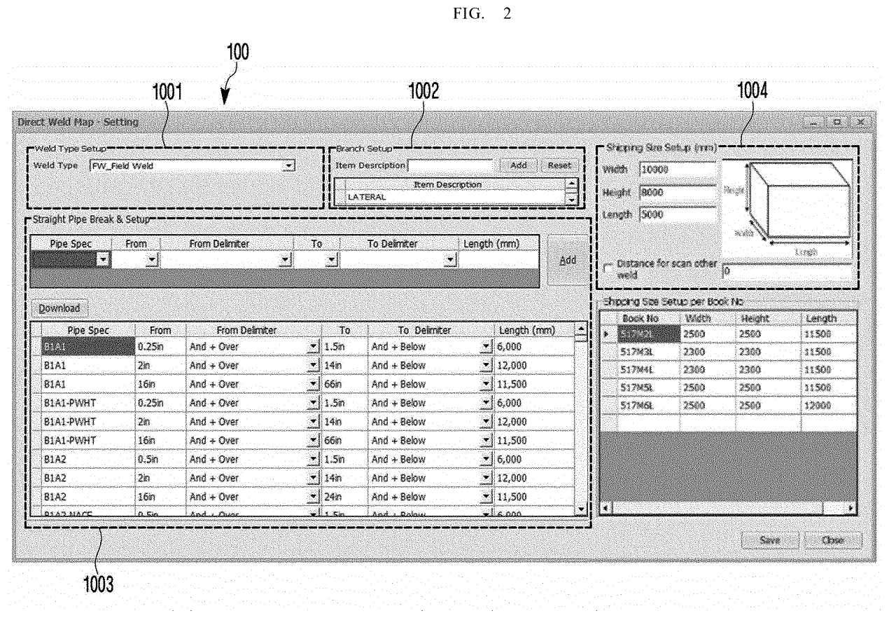

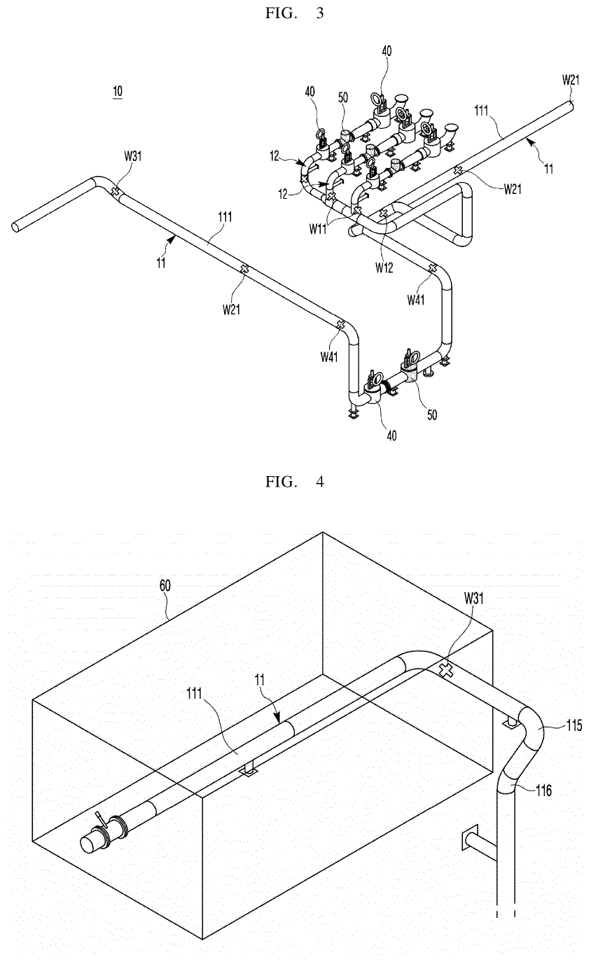

First, the method is subjected to the step (S1) of being modeled that the piping of the plant is divided into fabrication items or field erection items using a 3D modeling program for plant. While modeling the piping through a plant 3D modeling program, modeling is performed while distinguishing whether it is a fabrication item or a field erection item. When modeling is performed, fabrication items are set up as default, and only field erection items can be classified and modeled. As shown in FIGS. 2, 3D modeling of the piping is separately performed by distinguishing between a fabrication item 40 and an erection item 50. For modeling, the fabrication item 40 is set up as a default, and only the field erection item 50 can be modeled separately. In general, the field erection item 50 may correspond to a valve fastened with bolts or a special piping item fastened with bolts. In addition, it may be erected in the field by welding. And if the valve or the like is too large and it is difficult to fabricate due to interference with other pipes, it may be classified as a field erection item and modeled. In addition, an orifice or a venturi pipe, which is a piping item for which the direction of installation is important, may also be set up as a field erection item. FIG. 2 shows a fabrication item 40 and a field erection item 50.

Next, the method is subjected to the step (S2) of setting up a certain RULE for selecting a shop welding point and a field welding point in the modeled 3D piping, which is divided into a fabrication item or a field erection item. FIG. 3 is a configuration diagram of a user interface (UI) for setting up a RULE of the generating method of construction drawings of piping to include a weld map from 3D modeling of a plant according to the present invention. As shown in FIG. 3, a RULE for generating a weld map is a RULE for a piping item to which a field welding point is applied so that the field welding point can be automatically assigned to piping. Each RULE will be described below.

A RULE to which the field welding point is applied is the RULE which select the welding type in order that the field welding point is automatically set up. As shown in FIG. 3, the welding type in the user interface 100 is set up to field welding 1001.

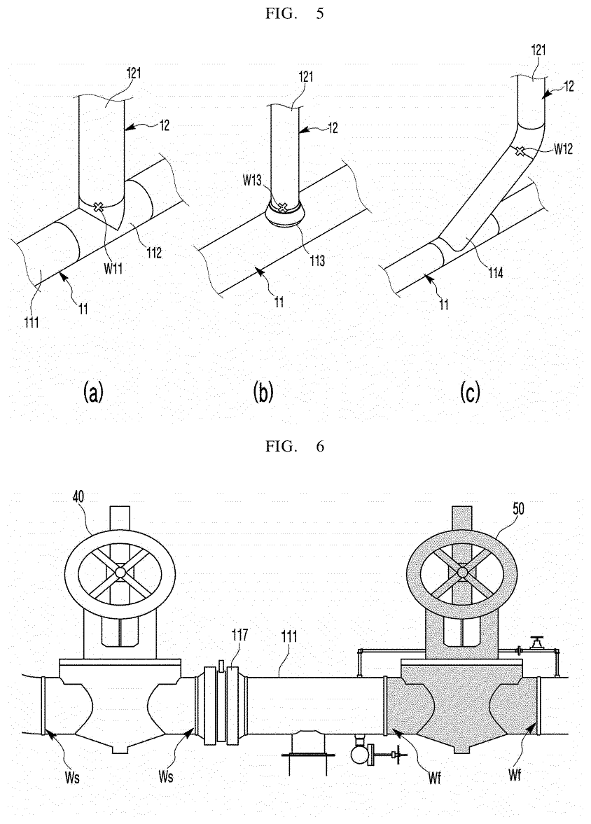

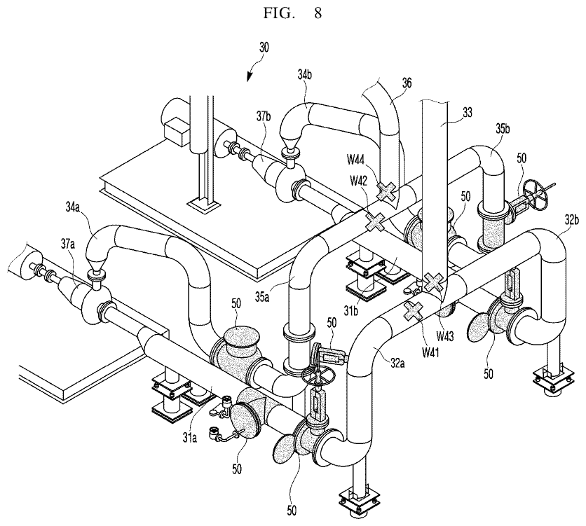

In addition, a RULE to which the field welding point is applied is the RULE 1002 applied to the branch pipe of TEE and LATERAL TEE and the branch pipe of OLET fitting. Among piping items, fittings in which branch pipes are formed include TEEs, LATERAL TEEs, and OLETs. A normal TEE is branched at 90°, and a LATERAL TEE is branched at 45°. Branch pipe branched from TEE or LATERAL TEE has a separate line number or can be changed in size, so it is applied to a field welding point. In addition, OLETs are fittings used when a branch pipe branched from the main pipe or a branch pipe with an outer diameter that a TEE cannot be used is connected. OLETs include SOCKOLET, WELDOLET, or LATROLET etc. SOCKOLET is often used when branch pipes with a diameter of 1 inch or less are connected, and WELDOLET is often used when branch pipes with a diameter of 2 inches or more are connected. LATROLET is similar to WELDOLET in that branch pipes of 2 inches or more are connected, but has a difference in that branch pipes are connected at 45°. Since the branch pipe is branched from the main pipe, one side of the OLET type can be shop welded to the main pipe, but the other side connected to the branch pipe is not suitable for shop welding, so it is set up as a field welding point. Referring to FIGS. 4 and 6, FIG. 4 is a three-dimensional view of the 3D modeling piping 10, and FIG. 6 shows a branch pipe 12 branched from the main pipe 11. FIG. 6(a) shows that the field welding point W11 is set up on the branch pipe side of the TEE 112 to which the branch pipe 12 is connected, and FIG. 6(b) shows a WELDOLET 113, type of OLET, is attached to be weld in the main pipe 11, and the branch pipe 12 is connected to the WELDOLET 113 by welding, and the portion to which the branch pipe 12 is attached is set up as a field welding point W13. FIG. 6(c) shows that the LATERAL TEE 114 is connected to the main pipe 11, and the side of the branch pipe 12 connected to the LATERAL TEE 114 is set up as a field welding point W12.

In addition, a RULE to which the field welding point is applied is the RULE 1003 set up to a certain length to be installed in the field according to the size and material class of the pipe, and both sides of the pipe set to a certain length are set up to be applied to the field welding point. Pipes supplied through pipe vendors (pipe manufacturers) are usually provided in a length of 6 m, but may be set up to a certain length according to the size such as the diameter of the pipe and material class. That is, the length of the pipe may be set up to 12 m according to the size or the material class of the pipe. The material class of a pipe refers to a material of the pipe and the thickness of the pipe according to the pressure that the material can withstand. The material class of pipe, that is, if the thickness of the pipe is thick, it is desirable for the length of the pipe to be set up to be long in order to shorten the welding point. In addition, the amount of welding in the field can be minimized by welding the pipe to a certain length in advance in the shop. Accordingly, both sides of the pipe of a certain length are set up to be applied as field welding points. Referring to FIG. 3, first, a pipe specification is set up, a range of sizes to be applied is set up, and a length is set up. Referring to FIG. 4, both sides of the straight pipe 111 are set up as field welding points W21.

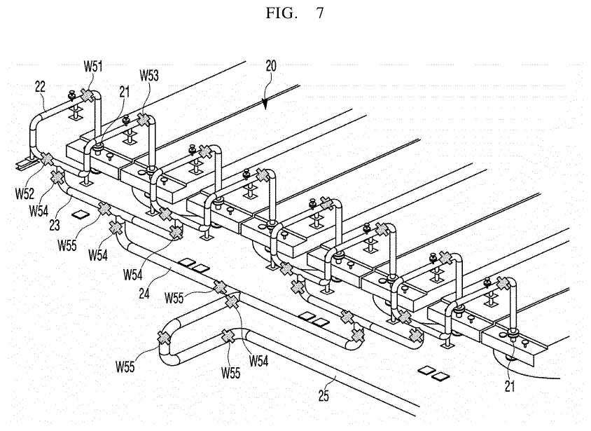

In addition, a RULE to which the field welding point is applied is the RULE 1004 set up to each end of the width, length or height of the pipe spool determined according to the size of the SHIPPING BOX in which the cargo is loaded, because the width, length or height of piping spool is determined according to the size of the SHIPPING BOX. Piping spools may also be fabricated off-site, shipped overseas, and shipped to the site. In this case, the length, width, and height of the spool may be determined according to the size of the SHIPPING BOX, which is the size of the container cargo loaded on the ship. In other words, it must be manufactured in a size that can fit into the size of shipping box which is container cargo. Accordingly, the width, length, and height of the spool are determined according to the width, length and height of the shipping box. And accordingly, each connection end of the spool entering the SHIPPING BOX is set as a field welding point W31 because it must be installed in the field. FIG. 5 shows setting the field welding point W31 according to the size of the SHIPPING BOX 60.

In addition, a RULE to which the field welding point is applied is the RULE which the field welding point Wf is applied to an item installed by welding among field erection items. The erection item can be welded on site or bolted to the flange. As shown in FIG. 2, an item installed by welding in the field is set as a field welding point. FIG. 2 shows that the field erection item 50 is set as the field welding point Wf. In addition, as shown in FIG. 2, since a fabrication item is manufactured in a shop, it is applied as a shop welding point Ws.

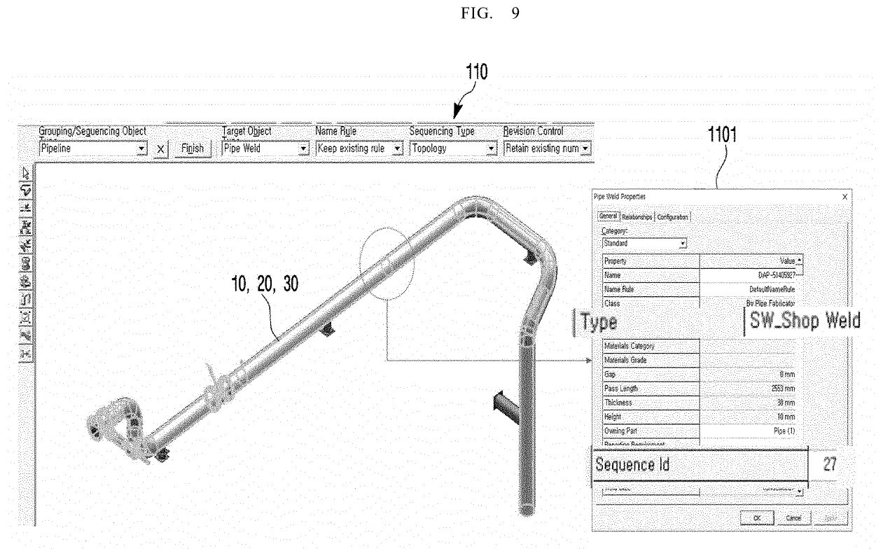

In addition, a RULE for a piping item to which a field welding point is applied is the RULE set as a field welding point in consideration of field installation for piping connected to two or more nozzles. FIG. 7 shows an example of piping connected to two or more nozzles. FIG. 7 shows an air fin cooler 20, and the number of nozzles 21 connected to the air fin cooler 20 is composed of two or more. In the drawing, the piping is connected in a tournament manner. The piping of FIG. 7 is formed in a certain pattern because the piping is formed in a tournament style. That is, a certain pattern comprises a pattern formed by a straight pipe and an elbow, and a pattern connected by a straight pipe, an elbow, and a tee are formed. Accordingly, shop welding points are applied to a certain pattern, but the connection ends of the certain pattern are set as field welding points (W51, W52, W53, W54, W55). Looking at the pattern of the piping, the pattern of the piping comprises a first piping 22 connected by a pair of nozzles is formed in an even number, a second piping 23 connecting the pair of a first piping 22 to each other, a third piping 24 connecting a pair of a second piping 23 to each other, and a fourth piping 25 connecting the pair of a third piping 24 to each other. A first to fourth piping are formed in a certain pattern and connected to each other. Therefore, since the piping of the air fin cooler 20 shows a tournament type configuration, a certain pattern can be formed, and the connection end of the certain pattern is set as a field welding point.

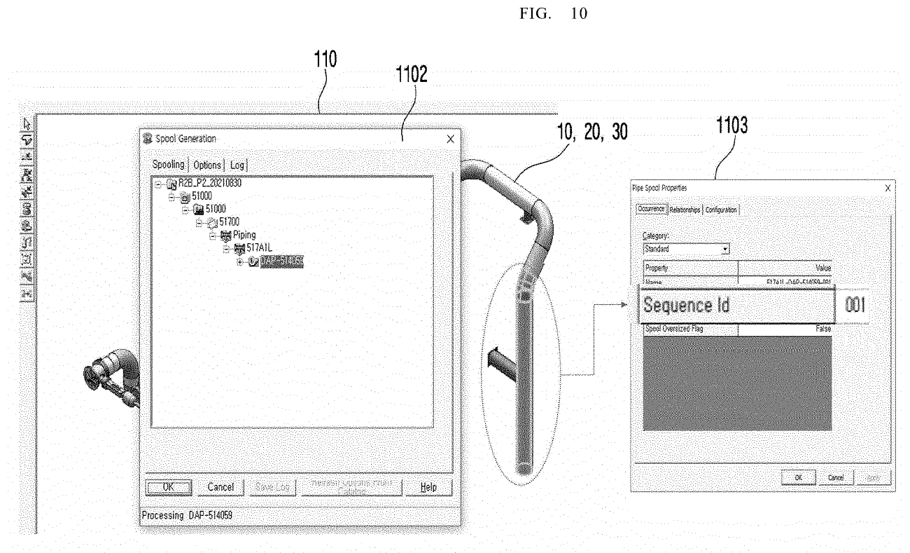

In addition, a RULE for a piping item to which a field welding point is applied is the RULE set as a field welding point in consideration of field installation for piping connected to machines operated in parallel. As shown in FIG. 8, the piping 30 of the parallel operation machine refers to the piping connected and installed such that two machines can be operated in parallel with each other, such as pumps 37a and 37b. That is, when one is activated, the other is maintained in a stand-by state. Since the two machines are installed side by side and fluid flows in and out alternately in each machine, piping must be connected to both machines. As shown in FIG. 8, the inlet side of the one-side pump 37a comprises the one-side lower inlet pipe 31a connected to the one-side pump 37a, and the one-side intermediate inlet pipe 32a which the lower side is connected to the one-side lower inlet pipe 31a and the upper side is connected to the common inlet pipe 33. In addition, the inlet side of the other-side pump 37b comprises connected to the other-side lower inlet pipe 31b connected to the other-side pump 37b, and the other-side intermediate inlet pipe 32b which the lower side is connected to the other-side lower inlet pipe 31b and the upper side is connected to the common inlet pipe 33. As shown in the figure, one-side intermediate inlet pipe 32a and the other-side intermediate inlet pipe 32b are connected to each other through a TEE, and a common inlet pipe 33 is connected to the branch pipe side of the TEE. One-side lower inlet pipe 31a and the other-side lower inlet pipe 31b must be aligned to adjust the height of the support according to the ground state to prevent vibration caused by the motor driving of the pump. Accordingly, it is difficult to fabricate the part where the one-side intermediate inlet pipe 32a and the other intermediate inlet pipe 32b are connected to each other. For this reason, it is preferable to set up the part connected to the tee to the field welding points W41 and W43. A field erection item 50 is shown on the pump inlet side, and the field erection item 50 is a valve, strainer, etc., and is installed by welding or bolted to a flange in the field. The strainer serves as a filter to remove impurities contained in the fluid flowing into the pump, and since it must be installed according to the field conditions, the field welding point is applied.

In addition, the outflow side of one-side pump 37a consists of one-side outlet pipe 34a connected to the upper side of the one-side pump 37a, and one-side intermediate outlet pipe 35a which the lower side is connected to the one-side outlet pipe 34a and the upper side is connected to the main outlet pipe 36. The outflow side of the other-side pump 37b consists of the other-side outlet pipe 34b connected to the upper side of the other-side pump 37b, and the other-side intermediate outlet pipe 35b which the lower side is connected to the other-side outlet pipe 34b and the upper side is connected to the main outlet pipe 36. The one-side intermediate outflow pipe 35a and the other-side intermediate outflow pipe 35b need to be properly arranged and installed in consideration of the influence of supports and the field erection items, and interference of other pipes, etc. Accordingly, the connection portion between the one-side intermediate outflow pipe 35a and the other-side intermediate outflow pipe 35b connected to the TEE, and the portion where the main outflow pipe 36 is connected to the TEE are set as field welding points W42 and W44. A field erection item 50 is also installed on the outflow pipe side, and a check valve for preventing backflow to the pump and an on/off valve for controlling the outflow of the fluid may be field erection items.

A shop welding point is applied to a piping item to which the certain RULE for applying the field welding point is not applied. For example, as shown in FIG. 5, elbow 115 and 45° elbow 116 connected to pipe 111 are indicated by piping items to which shop welding is applied. In addition, as shown in FIGS. 7 and 8, the pipe connected to the elbow is subject to shop welding and is not indicated as a piping item to which the field welding point is applied.

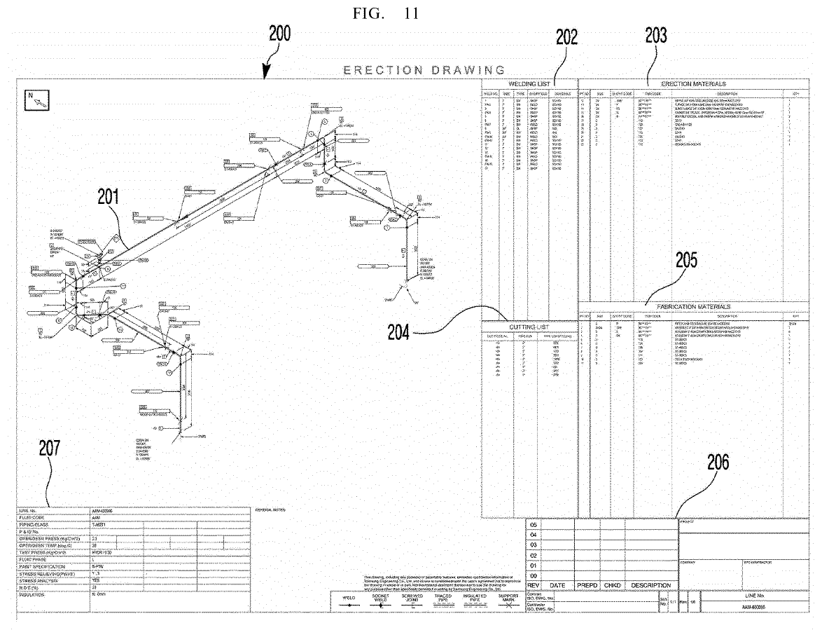

Next, the method is subjected to the step (S3) of marking a welding number to the 3D modeled piping by dividing into a shop welding point or a field welding point according to the certain RULE for each line number. Piping modeling is performed according to the Piping and Instrument Diagram (P&ID) of the plant, where a constant line number is given to the piping so that the piping can be distinguished. Accordingly, 3D modeled piping is modeled by line number, and the certain RULEs are applied to 3D modeled piping to mark the welding number. The welding number is marked together with the shop welding number and the field welding number. FIG. 9 is a 3D modeling UI 110 in which a welding number is marked. As shown in the drawings, the 3D modeled piping 10, 20, 30 is assigned a serial number of the welding type and welding number to indicate whether it is a shop welding point or a field welding point for each welding point. That is, when the connection part of the 3D modeled piping is clicked, the weld property UI 1101 is popped up, and the welding type and welding number can be checked in the UI 1101.

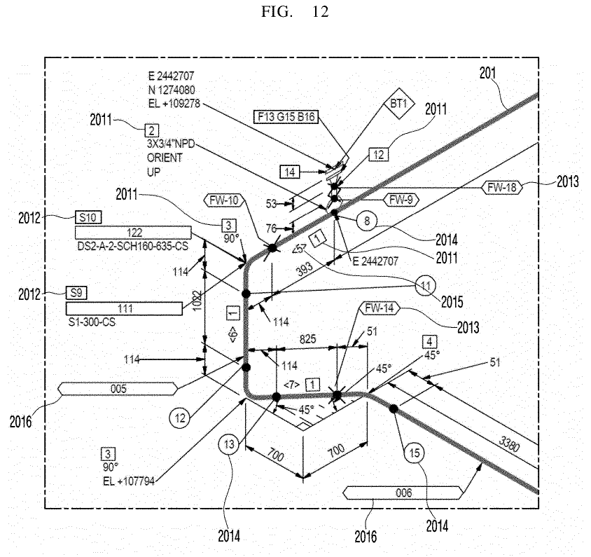

Next, the method is subjected to the step (S4) of marking a spool number on the piping to divide the piping with the welding number for each line number into fabrication drawings. A spool drawing refers to a drawing for fabrication at a shop or a certain place in the field. Accordingly, the spool drawing corresponds to a fabrication drawing, and all components thereof are included in the erection drawing. FIG. 10 is the same UI 110 as FIG. 9, which displays the structure 1102 of the Work Breakdown Structure (WBS) where the spool is located, and shows that the number in the spool order 1103 is set by clicking the lowest item.

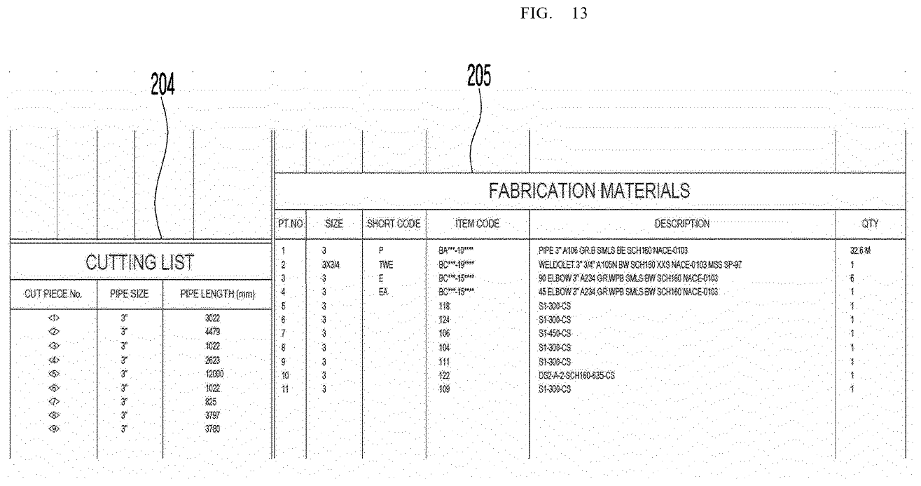

Next, the method is subjected to the step (S5) of generating an erection drawing by dividing the piping with the welding number and the spool number by line number. FIG. 11 illustrates an erection drawing generated from 3D modeling. The erection drawing was output by setting up the RULE for selecting shop welding points and field welding points. As shown in the drawing, in the erection drawing 200, a piping 201 with a certain route is drawn on the drawing, and information for the piping is written on one side of the piping 201. Information listed on one side include a welding list 202 with a welding number, a field erection material specification 203 on one side of the welding list 202, a pipe cutting list 204 on the lower side of the welding list 204, and a fabrication material specification 205 on one-side of the cutting list 204. Design data 207 such as line number and pressure in the piping are displayed on the lower side of the piping 201, and heading portion 206 such as project names are displayed on one-side of the design data 207.

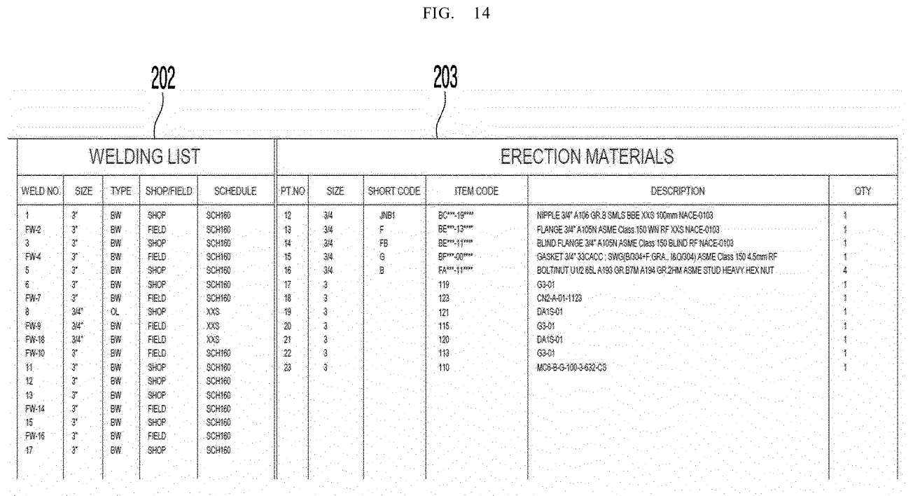

FIG. 12 is an enlarged view of a part of the piping route 201. The part number (PT. NO) 2011 is displayed in the square box on the drawing, and the material specification of the part number can be checked by finding the part number of the field erection material specification 203. Referring to part number 12 to FIG. 13, the size is ¾ inches, the SHORT CODE is JNB1, the item code is displayed in BC**-19**, and the detailed description is NIPPLE ¾″ A106 GR. B SMLS BBE XXS 100 mm NACE-0103 and the quantity is 1. Next, there is the support number 2012 displayed in the square box. Since the support number 2012 is also one of piping part, it is displayed in the part number. S10 means the part number of ‘10’ for support, and referring to the fabrication material specification 205 of FIG. 14, the part number 10 has the information as the item code is 122, and the detailed description for support is DS2-A-2-SCH160-635-CS which is written in code. The welding number is indicated by the field welding number 2013 and the shop welding number 2014. Specifically, the field welding number 2013 is indicated by ‘FW-18’, and the shop welding number 2014 is indicated by Arabic numerals such as 1, 2, 3, etc. As shown in the drawing, PT. NO ‘2’ in FIG. 12 shows that ¾″ of OLET is welded to the 3″ pipe. Specifically, PT. NO. ‘2’ in FIG. 14 is indicated as WELDOLET in the description, and the welding type of PT. NO. “2” in FIG. 12 is indicated by the shop welding number “8”, and the “8” of the welding list 202 is indicated by the shop welding point, accordingly it can be seen that PT. NO. “2” is a fabrication item. In addition, since the nipple attached to the WEDOLET is marked as ‘FW-18’, it can be seen that it is a field-welded item as indicated in the welding list 202. Also, <1> and <2> are the cutting list of pipes, and by identifying numbers such as <1> and <2>, it is possible to know how many cut pipes are required. The cutting list 204 requires nine cut pipes, and the size (3″ pipe) and length (32.6 m) of the pipe to be fabricated are also shown through the fabrication material specification 205. In addition, the spool number 2016 is indicated by 005, 006, etc., as shown in FIG. 12, and represents the spool number in a serial number according to the line number. In the erection drawing 200 of FIG. 11, it may be seen that the piping spool consists of six spools from 001 to 006.

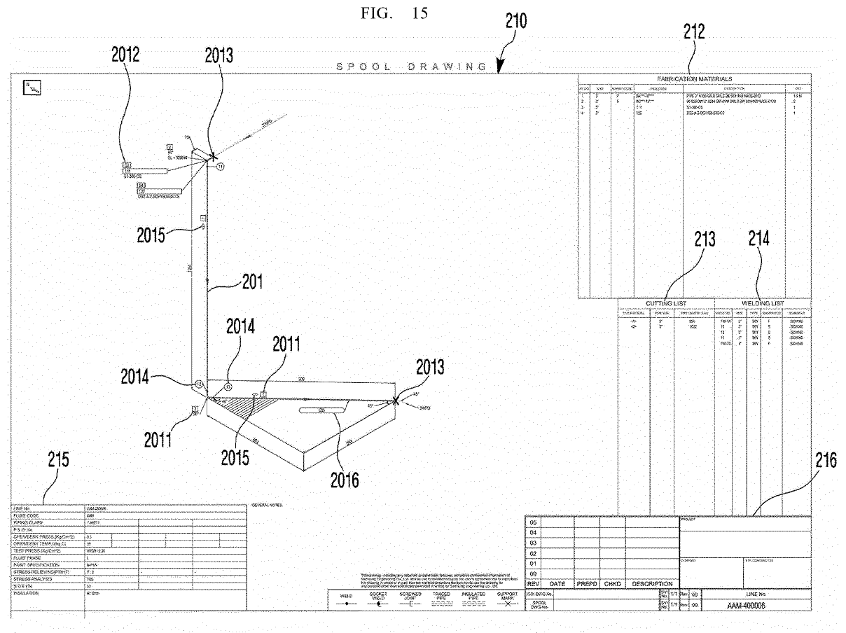

Next, the method is subjected to the step (S6) of generating a fabrication drawing for each spool number in order to manufacture a spool from the erection drawing. FIG. 15 illustrates a spool drawing 210. The spool drawing 210 displays a piping route 201, a fabrication material specification 211, a cutting list 212, and a welding list 213. The design data 215 and the heading portion 214 of the line number are the same as the erection drawing. In addition, the part displayed on the piping root 201 is the same as the erection drawing, and the materials, cutting numbers, and welding numbers required for spool fabrication are displayed on the fabrication material specification 211, cutting list 212, and welding list 213. That is, FIG. 15 is generated by dividing the drawing according to the spool number 2016 of FIG. 11, and both ends of the piping route 201 on the spool drawing are indicated by a field welding point 2013.

Through the above process, generation of a construction drawing of a piping including a weld map is completed from 3D modeling of a plant according to the present invention. Although the isometric drawing generated in the conventional 3D modeling does not include a weld map, this invention can dramatically reduce the working time due to the creation of the weld map because it is possible to generate an erection drawing including the weld map, and easily identify the welding amount of the entire pipe, which is advantageous for settling the welding amount after welding work. Accordingly, secondary effects such as shortening the construction period and reducing the labor force can also be brought.

As described above, the present invention can be made in various modifications, and preferred embodiments of the present invention have been described, but the present invention is not limited to these embodiments. In the claims and the detailed description of the present invention, it will be appreciated that the techniques that can be modified and used by those skilled in the art are included in the scope of the present invention.

1. A generating method of construction drawings of piping to include a weld map from 3D modeling of a plant using 3D modeling program implemented by a computer comprising the steps of:
(a) modeling the piping of the plant by dividing into a fabrication item or a field erection item using the plant 3D modeling program;
(b) setting up a certain RULE for selecting a shop welding point and a field welding point in the modeled 3D piping divided into the fabrication item or the field erection item;
(c) marking a welding number to the 3D modeled piping by dividing into a shop welding point or a field welding point according to the certain RULE for each line number;
(d) marking a spool number on the piping to divide the piping with the welding number for each line number into fabrication drawings;
(e) generating an erection drawing by dividing the piping with the welding number and the spool number by line number; and
(f) generating a fabrication drawing for each spool number in order to manufacture a spool from the erection drawing.

2. The generating method of construction drawings of piping to include a weld map from 3D modeling of a plant of claim 1, wherein in step (a), the piping is basically set up as a fabrication item, and the field erection item of the piping is modeled separately.

3. The generating method of construction drawings of piping to include a weld map from 3D modeling of a plant of claim 2, wherein in step (b), the certain RULE is for a piping item to which the field welding point is applied so that the field welding point can be automatically assigned to the piping.

4. The generating method of construction drawings of piping to include a weld map from 3D modeling of a plant of claim 3, wherein the certain RULE for the piping item to which the field welding point is applied is to be set up so that the field welding point is applied to the branch pipe side of the TEE and LATERAL TEE and the branch pipe side of the OLET fitting.

5. The generating method of construction drawings of piping to include a weld map from 3D modeling of a plant of claim 3, wherein the certain RULE for the piping item to which the field welding point is applied is to be set up so that the field welding point is applied to both sides of the pipe which the length of pipe erected in the field is determined by size and material class of pipe.

6. The generating method of construction drawings of piping to include a weld map from 3D modeling of a plant of claim 3, wherein the certain RULE for the piping item to which the field welding point is applied is to be set up so that the field welding point is applied to each connection end of the width, length or height of the spool which is determined by size of SHIPPING BOX which the cargo is loaded.

7. The generating method of construction drawings of piping to include a weld map from 3D modeling of a plant of claim 3, wherein the certain RULE for the piping item to which the field welding point is applied is to be set up so that the field welding point is applied to the field erection items installed by welding among the field erection items.

8. The generating method of construction drawings of piping to include a weld map from 3D modeling of a plant of claim 3, wherein the certain RULE for the piping item to which the field welding point is applied is to be set up so that the field welding point is applied to the piping connected to machines operated in parallel in consideration of the field erection.

9. The generating method of construction drawings of piping to include a weld map from 3D modeling of a plant of claim 3, wherein the certain RULE for the piping item to which the field welding point is applied is to be set up so that the field welding point is applied to piping connected to two or more nozzles in consideration of the field erection.
